(19) United States
(12) Patent Application Publication
(10) Pub. No.: US 2002/0091631 A1
(43) Pub. Date: Jul. 11, 2002

(54) E financial gift card

(75) Inventor: Tatsuo Usui, Tokyo (JP)

Correspondence Address: Edward D. Manzo, Esq., COOK, ALEX, McFARRON, MANZO,, CUMMINGS & MEHLER, LTD., 200 West Adams Street, Suite 2850, Chicago, IL, 60606-5234, US

(73) Assignee: International Scientific Co., Ltd.

(21) Appl. No.: 09/742,249

(22) Filed: Dec. 20, 2000

(30) Foreign Application Priority Data
Nov. 20, 2000 (JP) 353544/2000

(51) Int. Cl. G06F 17/60

(52) U.S. Cl. 705/39

(57) ABSTRACT

There is disclosed an E financial gift card which has anonymity and which can guard a card user's privacy. An E financial gift card 101 is distributed to a consumer from a card issuer 103 in a broad range. Examples of a distribution destination include a convenience store, restaurant, and the like. The simply distributed E financial gift card 101 is not validated, and is validated by following a predetermined procedure.

### REFERENCE TO RELATED APPLICATION

This application claims the priority right under Paris Convention of Japanese Patent Application No. 2000-353544 filed on Nov. 20, 2000, the entire disclosure of which is incorporated herein by reference.

### BACKGROUND OF THE INVENTION

i) Field of the Invention

The present invention relates to a financial card, particularly to an E financial gift card.

The E financial gift card is a card with which article purchase, cashing, and payment for eating and drinking can be performed by presenting card information of the validated card.

ii) Description of the Related Art

In recent years, a growth ratio of a consumer financial institution has continued to remarkably increase, and a service content has been enriched. In recent years, cooperation with a credit card company has been performed, and it has been possible to perform article purchase or payment for eating and drinking with cards issued by respective consumer financial companies.

However, when the aforementioned card is used to perform article purchase or eating/drinking, it is known to a payment destination or the third party that a card user itself is a debtor of the concerned financial operator. Such situation is disadvantageous for the card user in some case.

### SUMMARY OF THE INVENTION

The present invention has been developed in consideration of the aforementioned respect, and an object thereof is to provide an E financial gift card which has anonymity and which can guard privacy of a card user.

To achieve the aforementioned object, according to the present invention, there is provided a validation method of an E financial gift card having anonymity, comprising steps of: issuing the E financial gift card to a consumer; presenting card information of the E financial gift card to a predetermined financial operator or financial institution; making a loan contract between the financial operator or financial institution and the consumer; performing remittance of a contract amount to an issuer of the E financial gift card from the financial operator or financial institution; and confirming the remittance, and subsequently, validating the E financial gift card by the issuer.

Moreover, according to the present invention, there is provided a validation method of an E financial gift card having anonymity, comprising steps of: issuing the E financial gift card to a consumer; presenting card information of the E financial gift card, and performing money transfer to an issuer of the E financial gift card via a predetermined store; and confirming the transfer, and subsequently, validating the E financial gift card by the issuer.

The E financial gift card validation method can include steps of: performing point management of the validated E financial gift card together with the card information in accordance with a remittance amount and transfer amount to the issuer, and a payment amount with the E financial gift card.

In the E financial gift card validation method, the card information of the E financial gift card is a card ID and/or a password.

The E financial gift card validation method can include steps of: inquiring whether or not the E financial gift card is validated when the E financial gift card is used to perform replacement of an order for an article presented in a net shop; permitting acceptance of the order for the article when the E financial gift card is validated; and rejecting the acceptance of the order for the article when the E financial gift card is not validated.

The E financial gift card validation method can include steps of: inquiring whether or not the E financial gift card is validated when the E financial gift card is used to make a request for download of a content presented in a web site; permitting the download of the content when the E financial gift card is validated; and rejecting the download of the content when the E financial gift card is not validated.

The E financial gift card validation method can include steps of: inquiring whether or not the E financial gift card is validated when a request for cashing of the E financial gift card is made; permitting the cashing of the E financial gift card when the E financial gift card is validated; and rejecting the cashing of the E financial gift card when the E financial gift card is not validated.

### BRIEF DESCRIPTION OF THE DRAWINGS

FIG. 1 is an entire constitution diagram showing an embodiment of the present invention.

FIG. 2 is a time chart showing the embodiment of the present invention.

FIG. 3 is a time chart showing the embodiment of the present invention.

FIG. 4 is a time chart showing the embodiment of the present invention.

FIG. 5 is a time chart showing the embodiment of the present invention.

### DETAILED DESCRIPTION OF THE PREFERRED EMBODIMENTS

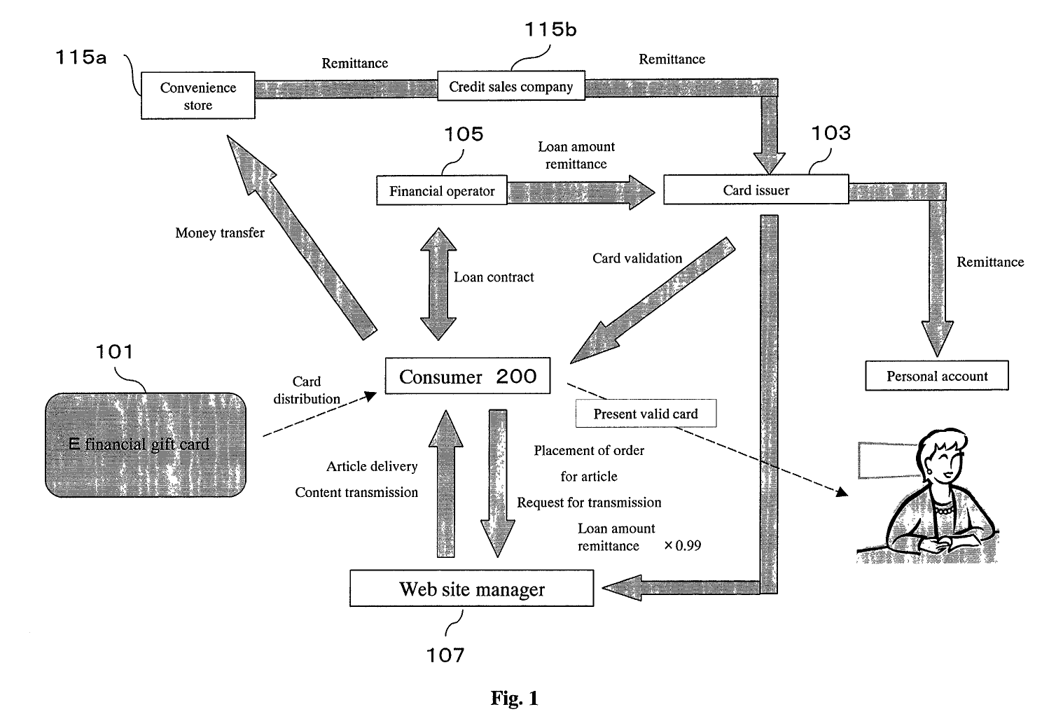

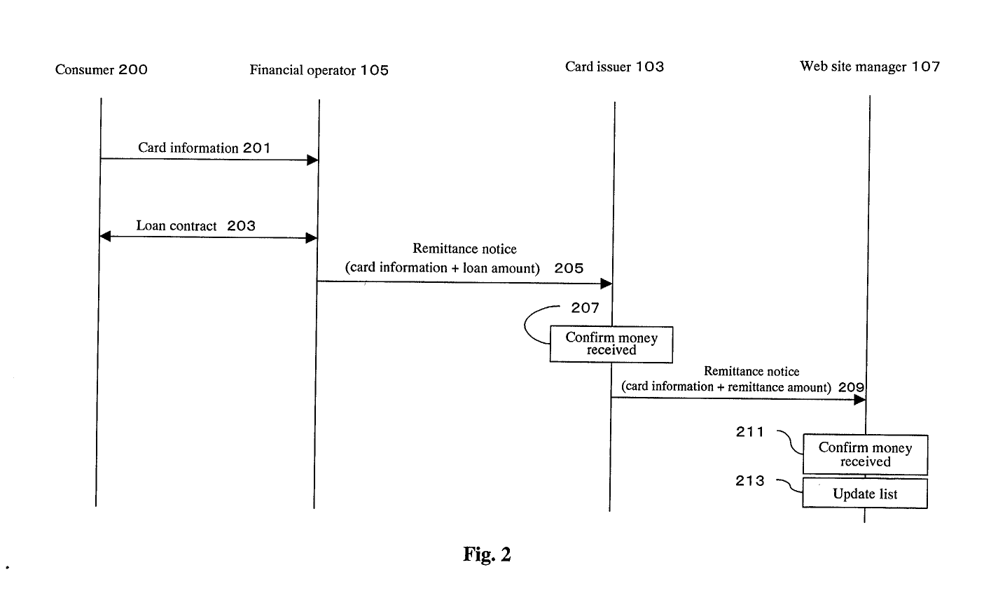

An embodiment of an E financial gift card according to the present invention will next be described in detail with reference to FIGS. 1 to 5. FIG. 1 is an entire constitution diagram showing the embodiment of the present invention, and FIGS. 2 to 5 are time charts showing the embodiment of the present invention. Additionally, solid-line arrows of FIGS. 2 to 5 show various types of information transmitted to an end point from a start point of the arrow via an electric communication circuit. Moreover, in the present embodiment, a case in which a loan amount is one million yen will be described as an example. Furthermore, in the present embodiment, information constituted by combining a “card ID” given to each card with a “password” given to each consumer is referred to as “card information”.

An E financial gift card 101 shown in FIG. 1 is distributed to a consumer from a card issuer 103 in a broad range. Examples of a distribution destination include a convenience store, a restaurant, and the like. The simply distributed E financial gift card 101 is not validated, but is validated by performing the following procedure.

1. Procedure for Card Validation

1-A. Validation by Loan Contract with Financial Operator 105

Validation of the E financial gift card 101 according to the present invention will be described with reference to FIG. 2.

(1) A consumer 200 presents card information of the E financial gift card 101 to a predetermined financial operator 105 (201), and a loan contract is made between the financial operator 105 and the consumer 200 (203). A loan amount is determined between the financial operator 105 and the consumer.

(2) Upon completion of the loan contract, remittance of a contract amount is performed to the card issuer 103 from the financial operator 105. In FIG. 2, remittance notice information including the card information is transmitted to the card issuer 103 from the financial operator 105 via the electric communication circuit (205).

(3) After confirming money received into the concerned account (207), the card issuer 103 validates the E financial gift card 101.

(4) The validated card 101 is subjected to point management together with the card information, a point is added in accordance with a remittance amount every time the remittance is performed to the card issuer 103 from the financial operator 105, and the point is subtracted in accordance with a payment amount with the validated card 101.

(5) An example of card validation will be described.

[1] Remittance to Web Site Manager 107

The card issuer 103 collects a predetermined proportion amount (e.g., 1.0%) of the remittance amount from the financial operator 105 as a system management charge, and remits the remaining amount (99% in this case) to a web site manager 107. In this case, since the remittance amount from the financial operator 105 is one million yen, the system management charge is 10,000 yen, and 990,000 yen is remitted to the web site manager 107. After confirming the remittance from the card issuer 103 together with the card information of the E financial gift card 101, the web site manager 107 starts a processing to recognize the E financial gift card 101 as a valid card.

In FIG. 2, the remittance notice information including the card information is transmitted to the web site manager 107 from the card issuer 103 via the electric communication circuit (209). After confirming the money received into the concerned account (207), the web site manager 107 establishes a correspondence between the card information of the E financial gift card 101 and a balance (initial value of 990,000 yen in this case) and stores this into a list (213). A data format example of this list is shown in table 1.

TABLE 1

| Card ID | Password | Balance |
|---|---|---|
| 00000001 | pass1111 | 990000 |
| 00000002 | gift2222 | 800000 |
| 00000003 | card3333 | 750000 |
| . | . | . |
| . | . | . |
| . | . | . |

[2] Card Validation in Card Issuer 103

After confirming the money received into the concerned account (207), the card issuer 103 establishes a correspondence between the card information of the E financial gift card 101 and the balance (an initial value of 990,000 yen in this case) and stores this in its own company list. The data format of the own company list is similar to Table 1.

1-B. Validation by Money Transfer at Convenience Store 115a

The validation of the E financial gift card 101 by money transfer at a convenience store 115a will next be described with reference to FIG. 1.

(1) The consumer 200 submits a money transfer sheet with the card information of the E financial gift card 101 put therein together with cash to the convenience store 115a. Transferred money is sent to the card issuer 103 via a predetermined credit sales company 115b or the like.

(2) After confirming the money received into the concerned account, the card issuer 103 validates the E financial gift card 101.

(3) The validated card 101 is subjected to the point management together with the card information, the point is added in accordance with a transfer amount every time the money transfer is performed to the card issuer 103, and the point is subtracted in accordance with the payment amount with the validated card 101.

(4) An example of the card validation is similar to the above 1-A(5).

2. Utilization Procedure of Validated E Financial Gift Card 101

<Utilization Procedure at Net Shop>

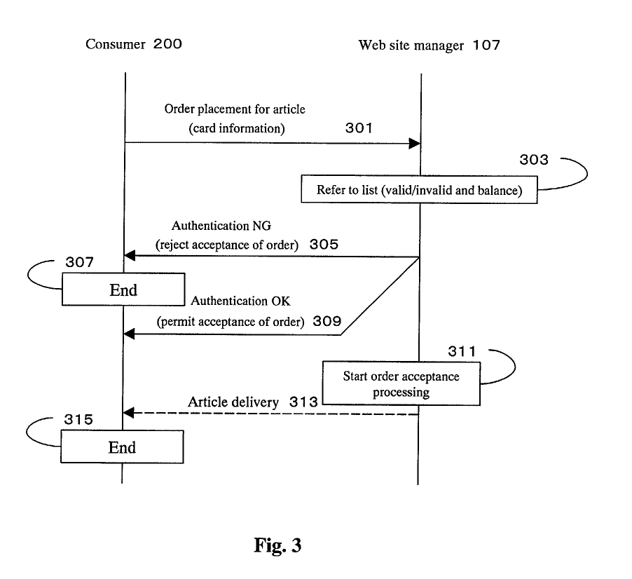

Utilization procedure of the E financial gift card 101 according to the present invention will next be described concretely with reference to FIG. 3. FIG. 3 shows an embodiment in which remittance is performed to the web site manager 107 from the card issuer 103 (FIG. 2) and a web site managed by the web site manager 107 is a net shop.

(1) The consumer 200 uses a cellular phone or the like connected to a personal computer or Internet to access the net shop managed by the web site manager 107.

(2) The consumer 200 who wants to place an order for an article presented in the net shop inputs the card information to place the order for the article (301).

(3) A server computer on the side of the web site manager 107 refers to the aforementioned list to confirm whether the E financial gift card 101 is valid/invalid from the inputted card information, and further confirms the balance when the card is valid (303).

[1] Valid Card

(i) Balance≧Article price . . . Acceptance of order for the article is permitted (309).

(ii) Balance<Article price . . . Acceptance of order for the article is rejected (305).

[2] Not-Valid Card (Invalid Card)

Acceptance of order for the article is rejected (305).

When the acceptance of order for the article is rejected (305), the processing ends (307). When the acceptance of order for the article is permitted (309), an order acceptance processing is started (311), the article is delivered to the consumer 200 and the processing then ends (315).

<Utilization Procedure in Content Site>

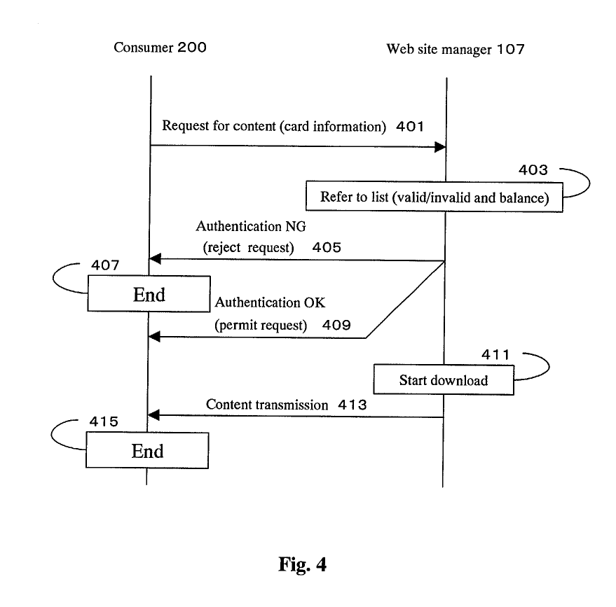

Utilization procedure of the E financial gift card 101 according to the present invention will further be described in detail with reference to FIG. 4. FIG. 4 shows an embodiment in which remittance is performed to the web site manager 107 from the card issuer 103 (FIG. 2), and a web site managed by the web site manager 107 is a content site.

(1) The consumer 200 uses the cellular phone or the like connected to the personal computer or Internet to access the content site managed by the web site manager 107.

(2) The consumer 200 who wants to download a content (including a text file, music file, and image file) presented in the content site inputs the card information to make a request for the content (401).

(3) The server computer on the side of the web site manager 107 refers to the aforementioned list to confirm whether the E financial gift card 101 is valid/invalid from the inputted card information, and further confirms the balance when the card is valid (403).

[1] Valid Card

(i) Balance≧Content charge . . . Download is permitted (409).

(ii) Balance<Content charge . . . Download is rejected (405).

[2] Not-Valid Card (Invalid Card)

Download is rejected (405).

When the download of the content is rejected (405), the processing ends (407). When the download of the content is permitted (409), the download is started (411), the content is transmitted to the consumer 200 and the processing then ends (415).

<Utilization Procedure for Cashing of Card>

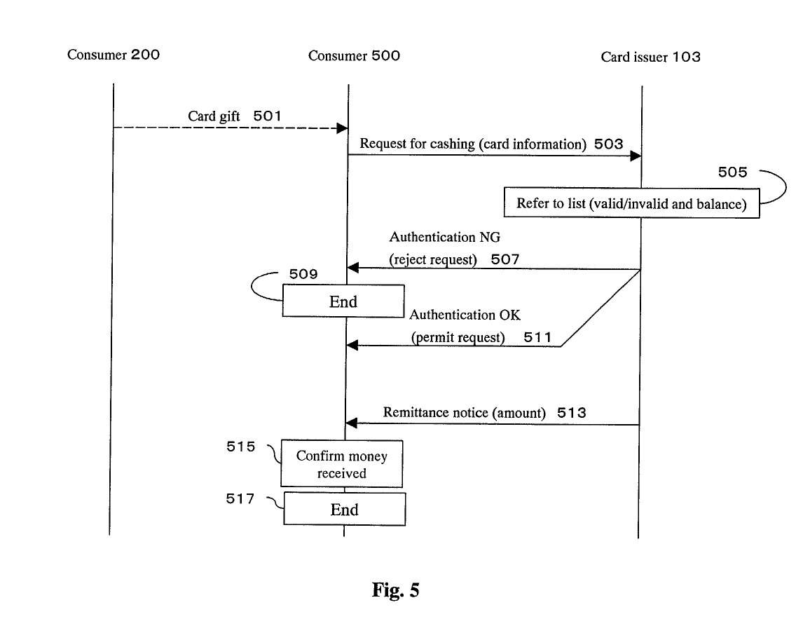

Utilization procedure of the E financial gift card 101 according to the present invention will further be described in detail with reference to FIG. 5. FIG. 5 shows an embodiment in which the E financial gift card 101 is cashed.

(1) In the present embodiment, it is assumed that the consumer 200 gives the E financial gift card 101 to another consumer 500 (501).

(2) The consumer 500 uses the cellular phone or the like connected to the personal computer or Internet to access the web site managed by the card issuer 103, and inputs the card information or the like to make a request for cashing (503).

(3) The server computer of the card issuer 103 refers to its own company list to confirm whether the E financial gift card 101 is valid/invalid from the card information, and further confirms the balance when the card is valid (505).

[1] Valid Card

(i) Balance≧Desired cashing amount . . . Cashing is permitted (511).

(ii) Balance<Desired cashing amount . . . Cashing is rejected (507).

[2] Not-Valid Card (Invalid Card)

Cashing is rejected (507).

When the cashing of the E financial gift card 101 is rejected (507), the processing ends (509). When the cashing of the E financial gift card 101 is permitted (511), the remittance notice information is transmitted to the consumer 500 from the card issuer 103 via the electric communication circuit (513). After the consumer 500 confirms the money received into the account (515), the processing ends (517).

The present embodiment has been described above in detail, but the present invention is not limited to the above description. For example, in the present embodiment the card issuer performs remittance to the web site manager, but the remittance can be performed to a real store (convenience stores, other various stores, restaurants, and the like) manager so that the card is utilized in article purchase in a real store.

Moreover, the remittance to the manager from the card issuer may be limited to one manager, or scattered to a plurality of managers.

Furthermore, in the present embodiment the case in which the consumer makes the loan contract with “financial operators such as a consumer financier” has been described, but “financial institutions such as a bank” may be used.

Additionally, in the present embodiment the case in which the consumer transfers money at the convenience store, and performs remittance to the E financial gift card issuer from the convenience store via the credit sales company has been described, but the consumer may transfer money at the financial institution (bank or the like), and perform remittance directly to an E financial gift card issuer's account from the financial institution.

As described above, according to the present invention, there can be provided the E financial gift card which has anonymity and which can guard card user's privacy.

What is claimed is:

1. A validation method of an E financial gift card having anonymity, comprising steps of:
issuing the E financial gift card to a consumer;
presenting card information of said E financial gift card to a predetermined financial operator or financial institution;
making a loan contract between said financial operator or financial institution and said consumer;
performing remittance of a contract amount to an issuer of said E financial gift card from said financial operator or financial institution; and
confirming said remittance, and subsequently, validating said E financial gift card by said issuer.

2. A validation method of an E financial gift card having anonymity, comprising steps of:
issuing the E financial gift card to a consumer;
presenting card information of said E financial gift card, and performing money transfer to an issuer of said E financial gift card via a predetermined store; and
confirming said money transfer, and subsequently, validating said E financial gift card by said issuer.

3. The E financial gift card validation method according to claim 1 or 2, further comprising steps of:
performing point management of the validated E financial gift card together with the card information in accordance with a remittance amount and transfer amount to said issuer, and a payment amount with said E financial gift card.

4. The E financial gift card validation method according to claim 1 or 2,
wherein the card information of said E financial gift card is a card ID and/or a password.

5. The E financial gift card validation method according to claim 1 or 2, comprising steps of:
inquiring whether or not said E financial gift card is validated when said E financial gift card is used to perform placement of an order for an article presented in a net shop;
permitting acceptance of the order for said article when said E financial gift card is validated; and
rejecting the acceptance of the order for said article when said E financial gift card is not validated.

6. The E financial gift card validation method according to claim 1 or 2, comprising steps of:
inquiring whether or not said E financial gift card is validated when said E financial gift card is used to make a request for download of a content presented in a web site;
permitting the download of said content when said E financial gift card is validated; and
rejecting the download of said content when said E financial gift card is not validated.

7. The E financial gift card validation method according to claim 1 or 2, comprising steps of:
inquiring whether or not said E financial gift card is validated when a request for cashing of said E financial gift card is made;
permitting the cashing of said E financial gift card when said E financial gift card is validated; and
rejecting the cashing of said E financial gift card when said E financial gift card is not validated.
